(19) United States
(12) Patent Application Publication
(10) Pub. No.: US 2007/0076898 A1
(43) Pub. Date: Apr. 5, 2007

(54) Adaptive beamformer with robustness against uncorrelated noise

(75) Inventors: Bahaa Eddine Sarroukh, Eindhoven (NL); Cornelis Pieter Janse, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninkiljke Phillips Electronics N.V.

(21) Appl. No.: 10/579,928

(22) PCT Filed: Nov. 18, 2004
(86) PCT No.: PCT/IB04/52474

§ 371 Date: May 19, 2006

(30) Foreign Application Priority Data
Nov. 24, 2003 (EP) 03104334.2

(51) Int. Cl. H04R 3/00

(52) U.S. Cl. 381/92; 381/122

(57) ABSTRACT

The relatively robust adaptive beamformer, comprises: a filtered sum beamformer (107) to process input audio signals (u1, u2, u3) from an array of respective microphones (101, 103, 105), and arranged to yield as an output a first audio signal (z) predominantly corresponding to sound from a desired audio source (160); and a noise estimation e.g. when incorporated in a sidelobe canceller topology an adaptive noise estimator (150), arranged to derive a noise signal (y) which is subtracted from the first audio signal (z) to obtain a noise cleaned second audio signal (r), and further comprises a scaling factor determining unit (170) arranged to provide a scale factor (S) as a function of a ratio (Q) of the sidelobe canceling, and being arranged to scale the adaptation step size with the scale factor (S), so that the sidelobe canceller only adapts quickly if it is relatively well locked on the desired audio source, but is rather insensitive to interference from noise sources.

The invention relates to an adaptive beamformer and a sidelobe canceller comprising such an adaptive beamformer.

The invention also relates to a handsfree speech communication device, voice control unit and tracking device for tracking an audio producing object, comprising such an adaptive beamformer or sidelobe canceller.

The invention also relates to a consumer apparatus comprising such a voice control unit.

The invention also relates to a method of adaptive beamforming or sidelobe canceling.

An embodiment of a sidelobe canceller and comprised beamformer (n.b. beamforner and sidelobe canceller can be named as corresponding apparatuses, since the beamformer inside a sidelobe canceller is adapted in a similar way as a stand-alone beamformer, both hence having the same problems which the special technical features of the invention solves) as announced in the first paragraph is known from the publication “C. Fancourt and L. Parra: The generalized sidelobe decorrelator. Proceedings of the IEEE Workshop on applications of signal processing to audio and acoustics 2001.” A sidelobe canceller is designed to lock in on a desired sound source, i.e. producing an output audio signal predominantly corresponding to the sound from the desired sound source, while rejecting as much as possible sound from other sources, called noise. To realize this the sidelobe canceller comprises an adaptive beamformer processing signals from an array of microphones, of which beamformer filters can be optimized, so that they represent the inverse of the paths of the desired audio from the desired sound source to each of the microphones (i.e. the desired audio is modified by e.g. reflecting off various surfaces and finally entering a particular microphone from different directions). By summing the filtered signals, the beamformer effectively realizes a direction sensitivity pattern which has a lobe of high sensitivity in the direction of the desired sound source. E.g. for filters which are pure delays, the beamformer realizes a sin(x)/x pattern with a main lobe and side lobes. The problem with such a sensitivity pattern however is that also sound from other sources may be picked up. E.g. a noise source may be situated in the direction of one of the side lobes. To resolve this problem, the sidelobe canceller also comprises an adaptive noise cancellation stage. From the microphone measurements, noise reference signals are calculated, by blocking the desired sound component from them, i.e. in the example the noise in the sidelobes is determined. By means of an adaptive filter from these noise measurements it is estimated how much of the noise sources leaks in the lobe pattern, directed towards the desired sound. Finally, this noise is subtracted from what is picked up in the main lobe, leaving as a final audio signal largely only desired sound. If a directivity pattern is calculated corresponding to this optimized sidelobe canceller, it contains a main lobe towards the desired sound source, and zeroes in the directions of the noise sources.

There are a number of problems with the prior art sidelobe canceller and beamformer, leading to the fact that in practice it does not work like it ideally should. Firstly, there is not necessarily a physical difference between sound from a desired sound source, e.g. a speaker, and sound form a noise source, e.g. sound of a motor. So instead of locking on to the speaker, the system may diverge towards the noise source, and have a main lobe towards a direction in between the desired sound source and the noise source. In the sidelobe canceller, this leads to the fact that the noise references contain speech or in general desired sound, and hence instead of canceling only noise from the sound picked up by the mainlobe, also part of the desired sound is cancelled. For speech this may be particularly unacceptable. The sidelobe canceller with microphone array may in some cases even work worse than a single microphone without sidelobe canceller. Such a noise coming from a particular direction (e.g. a second speaker) is called correlated noise, since each of the microphones picks up a related sound, e.g. a delayed version. Secondly there is the problem of so-called uncorrelated source, in which case the signals of the microphones are orthogonal. Uncorrelated noise can originate e.g. from the diffuse sound field (many independent sources such as e.g. from reverberation, or wind noise for a car), or just electronic noise in the microphones. This noise can also interfere with the functioning of the sidelobe canceller. Prior art sidelobe cancellers may contain a speech detector to try to solve these problems. It is assumed that the desired sound source is a speaker, and the noise sources are not. The beamformer is only adapted if it receives speech, typically by a maximization of its output power. If the noise canceling filters are incorrectly adapted, they leave a residual noise on the desired speech final output, which should be minimized. Hence, when there is only noise detected, the final output is minimized rather than maximized to obtain optimized noise canceling filters. There are two problems with such a speech detector. Firstly, the sidelobe canceller cannot lock onto non-speech signals such as e.g. needed for pointing a camera towards an apparatus producing audio communication sounds, and secondly, and more importantly, such speech detectors are not very robust, making such sidelobe cancellers still relatively bad. Good beamformers/sidelobe cancellers are especially difficult to design for environments in which the direction of the desired sound source and/or the noise sources are changing, hence for which the filters may have to re-adapt during relatively short time intervals. However this situation is quite common, e.g. in a teleconference system which attempts to track a speaker moving through a room, or in a system with a person speaking to a sidelobe canceller incorporated in a mobile phone, and together with the mobile phone moving through a variable environment, such as e.g. encountered with a handsfree car phone kit. What was described for a sidelobe canceller is also a problem for an adaptive beamformer associated with another noise removal strategy.

It is a first object of the invention to provide an adaptive beamformer which is relatively robust against the influences of noises. This first object is realized in that the adaptive beamformer comprises:
a filtered sum beamformer arranged to process input audio signals from an array of respective microphones, and arranged to yield as an output a first audio signal predominantly corresponding to sound from a desired audio source, by filtering with a first set of respective adaptable filters the input audio signals, the filtered sum beamformer being adaptive in the sense that coefficients of the first set of adaptable filters are susceptible to be changed by adding to at least one coefficient a difference value, obtained as a function of an adaptation step size; and
a scaling factor determining unit, arranged to provide a scale factor evaluated as a first function, of a ratio of a first variable being an estimate of the non-noise corrupted audio signal originating from the desired sound source present in the first audio signal, and a second variable being an estimate of the noise present in the first audio signal, the adaptive beamformer being arranged to scale the adaptation step size with the scale factor.

A more continuous evaluation (than with the above speech detector) of whether the adaptive beamformer is locking on the desired sound or not is desired for a robust adaptive beamformer, not just a binary speech/non speech decision, since with such a continuous function, the adaptive beamformer can afford to make evaluation mistakes. If with the binary criterion noise is erroneously identified as speech, the beamformer will start adapting fully to the noise and hence become non-optimal. A mechanism is needed with which in cases of erroneous adaptation of the beamformer in response to incoming noise, the beamformer is only adapted a little in parameter space. This can be realized by making the adaptation step dependent on the outcome of a function indicating how well the beamformer is optimized and how much noise is coming in, capable of making the beamformer non-optimal. These two factors together can be grouped in an equation specifying a scale factor being a function F1 of a ratio of
1) any variable indicative of the desired audio signal (e.g. speech) (e.g. the first audio signal itself should it be almost perfect, but preferably a further processed version thereof, in which noise which could not be cancelled by the beamformer is largely removed by another method, e.g. sidelobe canceling). Theoretically it can be understood that this is the audio actually emanating from the desired audio source and then modified (filtered) by e.g. room propagation, microphone transfer function etc. (but not corrupted by electronic circuit noise, correlated and uncorrelated noise from other, non-desired audio sources, . . . ); and
2) any variable indicative of the noise in an (output) audio signal processed to become nearer to the desired speech/audio.

If this function is large, it indicates that the beamformer is doing its job rather well, and that it will probably also adapt well, so a large adaptation step may be used, so that moving desired sound sources can be tracked. Vice versa, if the function indicates that the beamformer is not or cannot be working well (e.g. due to the presence of a strong interfering noise source, making the ratio small), the adaptation step size should be made small, since the filtered sum beamformer filter coefficients will not adapt to the correct values, but rather become even more wrong. The beamformer filters would otherwise be steered largely or partly by noise. The adaptation step is hence taken to be proportional to the scale factor.

The adaptive beamformer, or any of its embodiments, may be comprised in a sidelobe canceller, which further comprises:
an adaptive noise estimator, arranged to derive an estimated noise signal by filtering respective noise measurements derived from the input audio signals with a second set of adaptable filters; and
a subtracter connected to subtract the estimated noise signal from the first audio signal to obtain a noise cleaned second audio signal.

There is now a second set of adaptable filters (g1, g2), which are related to the filters of the filtered sum beamformer, and which estimate the contribution of the noise in the desired signal outputted from the beamformer. This estimated noise signal will in general be a more reliable noise estimate than e.g. a simple single noise measurement x1, provided of course that all filters are reasonably well adapted. For a beamformer, the first audio signal (z) is not orthogonal to the noise, since e.g. correlated noise will be present in both. With a sidelobe canceller this is largely resolved: a better noise estimate (y) and a better (cleaned) version of the desired speech (r) are approximately orthogonal.

The sidelobe canceling is working well if desired audio is inputted together with noise of a type for which the sidelobe canceller is optimized to cancel it (i.e. a few correlated noise sources in directions for which the direction sensitivity pattern has zeroes), as contrasted to the sidelobe canceller working badly if the filters are not optimal (i.e. e.g. the main lobe is directed in between the direction of the desired sound source and a direction of a noise source) and/or there is uncorrelated noise. If the sidelobe canceller is mainly picking up the desired sound, it may adapt with a large adaptation step size, to be able to quickly track a moving desired source. If however the sidelobe cancellation is having problems staying focused on the desired sound source (e.g. because of interfering noise sources), it will probably become even worse with a large adaptation step size (especially if it is only slightly misadapted), and hence the adaptation step size should be small. A similar rationale applies to the noise estimator/canceller, which is vice versa designed to adapt mainly to noise and not to the desired signal, e.g. speech. With such a continuous evaluation both the filtered sum beamformer and the noise estimator of the noise canceller can be adapted simultaneously if so desired, or each in its own complementary time intervals as with a prior art speech detector.

It is noted that the noise estimate (y) for canceling by the subtracter 142 from the first audio signal (z) need not be the same as the noise estimate for evaluating the step size. This is preferably a function A(xi) of the primary noise estimates x1, x2, x3, estimated by a noise estimator 310. This estimate of the noise present in the first audio signal may of course be taken to be y itself (in which case the noise estimator 310 is physically integrated as one component with the adaptive noise estimator 150). However in some situations other estimates may perform better (e.g. if this adaptive noise estimator 150 does not yield a large or reliable y signal because there is little correlation between the first audio signal z and the reference signals after the blocking matrix). A non-linear function may then e.g. be used like the sum of the powers of noise reference signals (good for a lot of diffuse noise like the so-called “babble noise” of many background speakers at a party).

A first embodiment of the adaptive beamformer or of the sidelobe canceller comprising such an adaptive beamformer has the coefficients of the first set of filters (f1(−t), f2(−t), f3(−t)) specified in the frequency domain, and is arranged for having the adaptation step size scaled per predetermined frequency range by the ratio (Q) being (P_{zz}[f,t]−CP_{A(xi)A(xi)}[f,t])/P_{zz}[f,t] in which P_{zz}[f,t] is a measure of the power of the first audio signal (z) in the predetermined frequency range around frequency f and for a time instant t, P_{A(xi)A(xi)}[f,t] is a measure of the power of a noise signal derived by a noise estimation unit (310) from at least one noise measurement (x1) by a transformation A, and C is a constant.

Instead of the power, also the amplitude or another function of the amplitude of the signals used in the ratio equation may be used.

An appropriate and preferable transformation A for the sidelobe canceller is the transformation produced by applying the noise estimation filtering on the noise estimates x1, x2, x3, and yielding the estimated noise signal y. In that exemplary case P_{A(xi)A(xi)}[f,t] reads P_{yy}[f,t].

The denominator is in this case a measure of speech/desired audio plus noise, and the numerator a measure of the desired audio (after the canceling of an estimate of the noise present, i.e. the subtracted term). This particular function has useful normalization properties.

The filters may already be well adapted for most frequencies, but a noise in a particular frequency band may appear or move relative to the sidelobe canceller. In this case only the coefficients in the particular frequency band need to be adapted. Hence preferred embodiments of the adaptive beamformer/sidelobe canceller according to the invention will work with filters specified in the frequency domain, although also time domain filters, or other representations may be used. In this first embodiment option the signal in the ratio equation being used as an estimate of the desired sound is the power of the first audio signal output by the beamformer. Instead of exactly taking the output of the beamformer, a number of elementary signal shaping operations may be performed before the first audio signal is taken to the scaling factor determining unit, e.g. since the noise estimation typically incurs an additional delay, a delay element is typically introduced behind the beamformer. It is then preferable to take the first audio signal after the delay, since this signal is in synchronization with the noise signal. If the sidelobe canceller is well adapted and there is little noise present, then the noise power in the above equation is negligible compared to the desired sound power, making the numerator approximately equal to the denominator. If vice versa there is a lot of noise present, the numerator will be small compared to the denominator, making the ratio small. The above equation has values between zero and one, implying that a suggested step size can be scaled between the suggestion and zero by simple multiplication with the above equation. Whereas the beamformer filters are typically adjusted by scaling their adaptation step size with the evaluation result from the above equation, the noise estimator/canceller filters are typically scaled with 1 minus that evaluation result.

A second embodiment of the sidelobe canceller has the coefficients of the first set of filters specified in the frequency domain, and is arranged for having the adaptation step size scaled per predetermined frequency range by the ratio (Q) being
(P_{zz}[f,t]−CP_{A(xi)A(xi)}[f,t])/Pᵣᵣ[f,t],
in which P_{zz}[f,t] is a measure of the power of the first audio signal (z) in the predetermined frequency range around frequency f and for a time instant t, P_{A(xi)A(xi)}[f,t] is a measure of the power of a noise signal derived from at least one noise measurement (x1) by a transformation A, Pᵣᵣ[f,t] is a measure of the power of the second audio signal (r), and C is a predetermined constant.

Instead of using the first audio signal as an estimate of the desired sound, also the second audio signal r may be used as reference signal. Since the second audio signal is obtained after subtracting residual noise from the first audio signal, it is supposed to be an even more accurate estimate of the desired audio signal. It is judged that a signal further in the processing line of algorithms for obtaining the desired signal forms a more accurate basis for a decision like e.g. whether the beamformer should adapt if the system is near optimum, but the resulting signal may also be far worse than an estimate obtained by a few simple algorithms if the sidelobe canceller is far from optimum. Hence when using such a sidelobe canceller topology for updating the filters a classical speech detector may lead to totally unacceptable results and a continuous criterion for scaling the step sizes may be the only viable option. Similar equations, and equivalent sidelobe canceller updating topologies, may be derived for using signals obtained after further processing—e.g. typically to further reduce the amount of residual noise, or to further clean up the desired sound or speech—as reference signal.

It is advantageous if the adaptive beamformer/sidelobe canceller comprises a speech detector providing on the basis of the first audio signal a Boolean designation Speech/Noise, and arranged to adapt only the first set of if the designation is Speech, and for the sidelobe canceller only the second set of filters if the designation is noise. The beamformer may then be arranged to only adapt its filters—with the scaled adaptation step size—in case the desired sound is speech.

It is also advantageous if the adaptive beamformer/sidelobe canceller is arranged to apply a binary decision function to the ratio, and arranged to adapt only the first set of filters if the decision is 1, and only the second set of filters if the decision is 0. E.g. values of either of the above two equations larger than 0.5 result in only the beamformer filters being updated, i.e. in a decision equaling 1, obtained in this example by rounding towards the nearest integer. Whereas a speech detector can only discriminate between speech and non speech noise—and often in an unreliable manner—using the ratio in a detector has the advantage that the sidelobe canceller can be used for locking onto all kinds of non speech desired sound, such as the sound of an animal like a singing bird, or a sound produced by an apparatus.

The adaptive beamformer and sidelobe canceller may typically be applied in all kinds of (e.g. typically handsfree) speech communication devices, e.g. a pod for teleconferencing to be placed on a table, or a car kit, or regular mobile phone, personal digital assistant, dictation apparatuses or other device with similar communication capabilities. The adaptive beamformer/sidelobe canceller is also advantageous in a voice-controlled apparatus, such as e.g. a remote control for a television, or a speech to text system on p.c., to improve the speech identification capabilities of the apparatus, noise being an important problem for those devices. Other devices may be all kinds of consumer devices, elevators or parts of intelligent houses, security systems, e.g. systems relying on voice recognition, consumer interaction terminals, etc.

The system may also be used in a tracking device, typically used in security applications, or applications which monitor user behavior for some reason. An example may be a camera that zooms in on a burglar based on his characteristic noise.

It is a second object of the invention to provide a method of sidelobe canceling corresponding to the functioning of the sidelobe canceller as described above.

The second object is realized in that the method comprising:

beamforming filtering input audio signals (u1, u2, u3) from an array of respective microphones (101, 103, 105) with a first set of respective adaptable beamforming filters (f1(−t), f2(−t), f3(−t)), yielding a first audio signal (z) predominantly corresponding to sound from a desired audio source (160), the beamforming filtering being adaptive in the sense that coefficients of the first set of adaptable filters (f1(−t), f2(−t), f3(−t)) are changeable by adding to at least one coefficient a difference value obtained as a function of an adaptation step size;
determining a scale factor (S) a first function (F1), of a ratio (Q) of a first variable (F2) being an estimate of the non-noise corrupted audio signal originating from the desired sound source (160) present in the first audio signal (z), and a second variable (F3) being an estimate of the noise present in the first audio signal (z); and
scaling the adaptation step size with the scale factor.

This method may typically be realized as software, e.g. stored on a server for downloading or transmitted to a consumer apparatus.

These and other aspects of the sidelobe canceller according to the invention will be apparent from and elucidated with reference to the implementations and embodiments described hereinafter, and with reference to the accompanying drawings, which serve merely as non-limiting specific illustrations exemplifying the more general concept.

In the drawings:

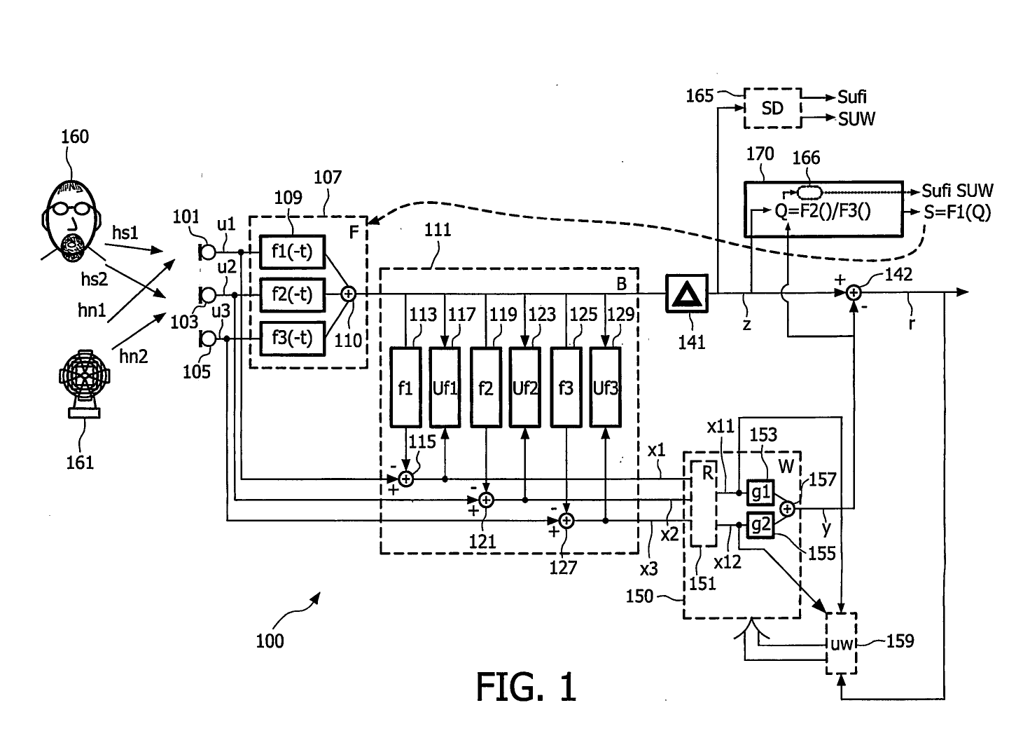

FIG. 1 schematically shows an embodiment of the sidelobe canceller corresponding to a ratio equation based on the first audio signal; and

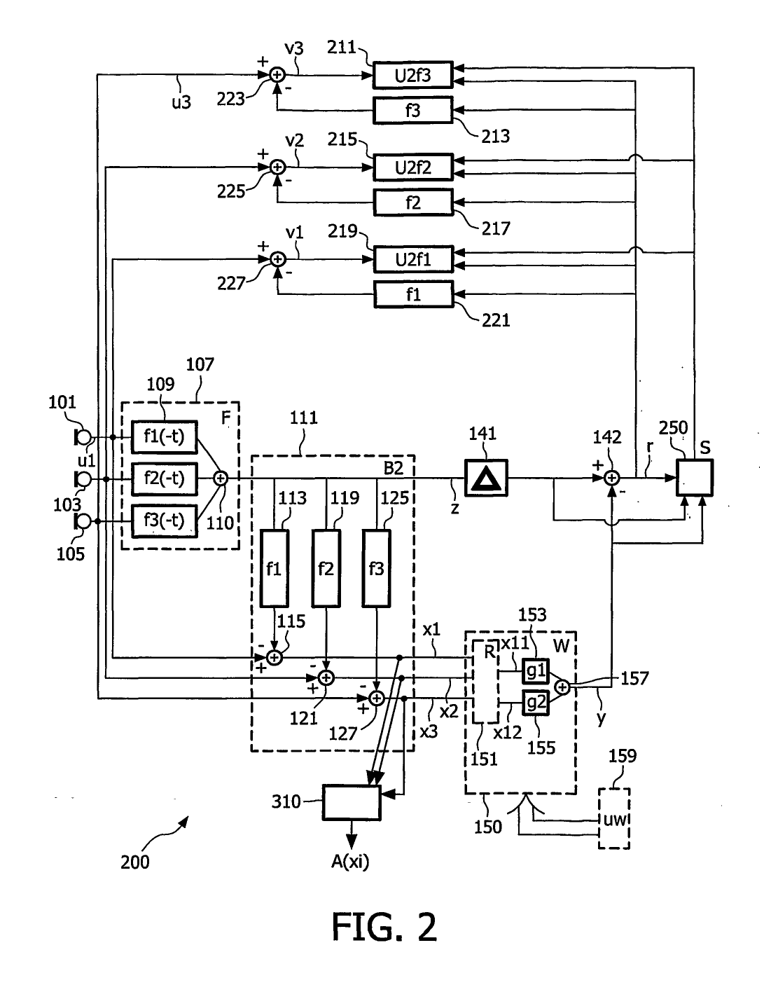

FIG. 2 schematically shows an embodiment of the sidelobe canceller corresponding to a ratio equation based on the second audio signal.

In FIG. 1, sound from a desired sound source 160, and possibly also form one or more undesirable noise sources 161, travels to an array of at least two microphones 101, 103, 105. The signals u1, u2, u3 output by these microphones are filtered by a first set of respective filters f1(−t), f2(−t), f3(−t) of a beamformer 107, the coefficients of which—typically a coefficient per band of frequencies—are adaptable to changing conditions in a room, e.g. of the desired sound source 160. The resulting signals outputted by the respective filters are summed by an adder 110, yielding a first audio signal z. Ideally the filters represent the inverse paths of the desired sound towards a particular microphone, hence by filtering a first microphone signal u1 by the first filter f1(−t) ideally exactly the desired sound is obtained. Hence, if the filters are well adapted, the first audio signal z is a good approximation to the desired sound. However, since the microphones also pick up noise, inevitably the first audio signal z also contains noise. The microphone signals u1, u2, u3 are also used to produce noise measurements x1, x2, x3. To obtain signals only representative of the noise, mathematically speaking orthogonal to the desired audio signal, the desired signal is subtracted from the microphone signals u1, u2, u3 by respective subtracters 115, 121, 127. A so-called blocking matrix 111 therefore reapplies the sound traveling path filters f1, f2, f3 on the first audio signal z, to obtain an estimate of the desired sound as picked up by the microphones. Hence the filters of the beamformer 107 and the blocking matrix are similar apart from a time reversal. An adaptive noise estimator 150 estimates on the basis of the noise measurements x1, x2, x3, as obtained by each of the microphones, how much noise will be picked up in a main lobe of the beamformer directed towards the desired source or another part of the lobe pattern directed towards the desired sound, such as a sidelobe of that pattern, hence what the contribution is of the noise in the first audio signal z. The noise estimator 150 therefore has to apply a second set of adaptable filters g1, g2, which are again related to the beamformer filters f1(−t), f2(−t), f3(−t). Because of mathematical dependency of one of the noise measurements x1, x2, x3 (there are only three microphone measurements leading to a desired audio signal being the first audio signal z and three noise measurements x1, x2, x3) before applying the second filters g1, g2, a dimension reduction may be applied. E.g. the third noise signal may be dropped, or x11 may be defined as x1−(x1+x2+x3)/3 and x12 may be defined as x2−(x1+x2+x3)/3, etc.

Alternatively three second filters may be adapted, the convergence automatically taking care of the dependency. Finally a subtracter 142 is comprised for subtracting the estimated noise signal y from the first audio signal z, the subtracter 142 and noise estimator 150 together constituting a noise canceller, yielding a second audio signal r, being relatively free of noise.

The above described system is a sidelobe canceller as known from prior art. Respective beamformer update units 117, 123, 129 for updating the filters of the beamformer 107 and blocking matrix 111 are shown in FIG. 1 as forming part of the blocking matrix, although this need not be so.

A typical update rule for a prior art beamformer may take the first audio signal z and a respective noise measurements as input and evaluate a new filter coefficient for a particular frequency range or band around frequency f:

$$F ( f , t + 1 ) = F ( f , t ) + \frac{α}{{P}_{zz} [ f , t ]} {z}^{*} [ f , t ] x [ f , t ] \qquad \text{[Eq. 1]}$$

In this equation F is the particular filter coefficient for a particular frequency range at discrete time t resp. t+1, α is a constant, P_{zz}[f,t] is a measure of the power of the first audio signal, x is the respective noise measurement (e.g. x1 for the first filter f1(−t)), and the star denotes complex conjugation. Hence if the noise is approximately orthogonal to the desired first audio signal z the filter coefficient is hardly updated.

A typical update rule in a prior art noise canceller update unit 159 for updating the second set of filters g1, g2 is:

$${G}_{1} ( f , t + 1 ) = {G}_{1} ( f , t ) + \frac{α}{{P}_{x 11 x 11} [ f , t ]} {x}_{11}^{*} [ f , t ] r [ f , t ] \\ {G}_{2} ( f , t + 1 ) = {G}_{2} ( f , t ) + \frac{α}{{P}_{x 12 x 12} [ f , t ]} {x}_{12}^{*} [ f , t ] r [ f , t ] , \qquad \text{[Eq. 2]}$$

in which r is the second audio signal, and P_{yy}[f,t] is a measure of the power of the noise signal y, and the x11 and x12 are the respective input noise estimates to the filters (for different topologies—e.g. different R-block—the skilled person can derive similar update rules from adaptive filter theory).

For the sidelobe canceller 100 according to the invention, these update steps (the part after the+sign) are scaled depending on the ratio determining how well the sidelobe canceller works.

Therefore a scaling factor determining unit 170 is comprised, which has as an input the first audio signal z—preferably after a delay by a delay element 141—and the noise signal y. It evaluates a ratio Q and as a function of the ratio a scaling factor S. The scaling factor S may for the sidelobe canceller updating topology e.g. be evaluated as:

$$S [ f , t ] = \frac{{P}_{zz} [ f , t ] - {CP}_{yy} [ f , t ]}{{P}_{zz} [ f , t ]} , \qquad \text{[Eq. 3]}$$

in which C is a predetermined constant, and the other terms have the same meaning as above.

This function should be lower limit to zero, i.e. it should not become negative. It should be noted that the time instants may be chosen in different ways (known to the skilled person) and preferably the processing is done on a block basis. It can be shown that Eq. 3 is approximately equivalent to:

$$S [ f , t ] \approx \frac{{P}_{AA} [ f , t ]}{{P}_{AA} [ f , t ] + {P}_{nn} [ f , t ]} ,$$

where A is the desired audio signal (e.g. speech of the desired speaker) and n is the noise, i.e. Eq. 3 is approximately equivalent to

$$S [ f , t ] \approx \frac{SNR}{SNR + 1} ,$$

i.e. a function of the signal to noise ratio SNR=P_{AA}[f,t]/Pₙₙ[f,t].

The skilled person will realize that other estimates of the noise may also be used, hence the noise estimator of the sidelobe canceller is not required. Any combination of an adaptable filtered sum beamformer (this concept also intended to comprise delay sum beamformers and similar topologies) and a noise reference, e.g. the signal picked up by any of the microphones, may be used to compose the core adaptive beamformer according to the invention.

The scaling factor S is transmitted to the beamformer update units 117, 123, 129 which are according to the invention arranged to scale the update step of the beamformer filters by multiplying the adaptation step size with the scaling factor S, yielding an updating rule according to the invention:

$$F ( f , t + 1 ) = F ( f , t ) + \frac{α ( {P}_{zz} [ f , t ] - {CP}_{yy} [ f , t ] )}{{{P}_{zz} [ f , t ]}^{2}} {z}^{*} [ f , t ] x [ f , t ] . \qquad \text{[Eq. 4]}$$

Similarly, by scaling the noise estimator filter adaptation step size with 1-S, the corresponding updating rules are:

$${G}_{i} ( f , t + 1 ) = {G}_{i} ( f , t ) + \frac{α ( {CP}_{yy} [ f , t ] )}{{P}_{x 1 ix 1 i} [ f , t ] {P}_{zz} [ f , t ]} {x}_{1 i}^{*} [ f , t ] r [ f , t ] . \qquad \text{[Eq. 5]}$$

Other functions of this ratio may be used provided that the noise estimator has a behavior inverse to the beamformer, i.e. the noise estimator predominantly reacts to signals containing mainly noise and little desired signal energy, e.g. picked up during speech pauses.

Instead of using CP_{yy} an alternative noise estimation unit 310 (only shown in FIG. 2, but of course freely combinable with all embodiments) may be present to evaluate an alternative measure of the noise still present in an estimate of the desired speech (e.g. z), which may e.g. be any linear or non-linear function of the noise measurements x1, x2, x3.

As can be seen for e.g. the beamformer filter updating (Eq. 4), if there is a lot of (correlated or uncorrelated) noise present, then CP_{yy}[f,t] is relatively large, making P_{zz}[f,t]−CP_{yy}[f,t] smaller than P_{zz}[f,t], which results in a small step size. If there is no noise at all, the scaling factor is equal to one.

A speech detector 165 as known from prior art may also be comprised. It is modified to be able to output a signal Sufi to the beamformer update units 117, 123, 129 in case the first audio signal z is identified as speech, and the beamformer update units 117, 123, 129 are arranged to only update the filters (f1(−t), f2(−t), f3(−t), f1, f2, f3) if the signal Sufi is of a particular value, e.g. 1. Similarly a signal SUW enables the adaptation of the noise estimator 150 filters g1, g2, only in case the speech detector 165 identifies the first audio signal z as being noise. The speech detection may also be applied to the second audio signal r as input. Note that in FIG. 1 for clarity of the picture the connections of signals Sufi and SUW to the update unit are not shown, but the are understood to be of known kinds such as e.g. wiring, saving and fetching from memory in a software version, etc.

In a further embodiment, the scaling factor determining unit 170 may comprise a sound type characterization unit 166. Similar to the speech detector 165 this unit identifies whether the sidelobe canceller is mainly locking on to the desired audio source or whether it is receiving a lot of noise. The sound type characterization unit 166 is e.g. arranged to apply a binary decision function to the ratio Q (e.g. rounding to the nearest integer, 0 or 1), and is as above arranged to output a signal Sufi to adapt the first set of filters (f1(−t), f2(−t), f3(−t) and also f1, f2, f3) only if the decision is 1, and the second set of filters (g1, g2) only if the decision is 0. This may increase the robustness of the sidelobe canceller 100 even further.

FIG. 2 shows a topology for which is arranged to perform the updating of the beamforming/blocking filters (f1(−t), f2(−t), f3(−t), f1, f2, f3) as a function of the second audio signal r. Therefore, second beamformer update units 219, 215, 211 are schematically shown above the prior art side canceller part as described before. The second beamformer update units 219, 215, 211 have as second input a similarly constructed set of second noise measurements v1, v2, v3, which are constructed with respective subtracters, e.g. subtracter 227 subtracting a filtered version of the second audio signal r with a first blocking filter f1 from the first microphone signal u1, and so on.

It can be proven mathematically that similar to eq. 1, a basic update formula may be intelligently chosen as:

$$F ( f , t + 1 ) = F ( f , t ) + \frac{α}{{P}_{rr} [ f , t ]} {r}^{*} [ f , t ] v [ f , t ] , \qquad \text{[Eq. 6]}$$

in which r is the second audio signal, v is one of the second noise measurements v1, v2, v3 corresponding to the particular beamformer filter to be updated and Pᵣᵣ[f] is a measure of the power of the second audio signal r.

A possible equation for the scaling factor for this sidelobe canceller topology 200, evaluated by a second scaling factor determining unit 250, is:

$$S [ f , t ] = \frac{{P}_{zz} [ f , t ] - {CP}_{yy} [ f , t ]}{{P}_{rr} [ f , t ]} . \qquad \text{[Eq. 7]}$$

The scaling of the beamformer 107 filters, blocking matrix 111 filters, and noise estimator 150 filters is done as described for the topology of FIG. 1.

If there is substantially only correlated noise and near perfect cancellation, the subtraction at subtracter 142 may be seen as a scalar equation, and by definition Pᵣᵣ[f]≈P_{zz}[f]−CP_{yy}[f], since r=z−y, making S approximately equal to 1. If the noise canceller is ill-adapted, e.g. due to movements of the noise source, since the phase of the noise is unknown the subtracter 142 can not perform a noise canceling. E.g. the amplitude of the noise may be estimated correctly, but if there is a phase difference of 180 degrees, the estimated noise signal y will be added to instead of subtracted from the first audio signal, only increasing the noise. Also due to leakage of a lot of energy—even of the desired sound—in the noise measurements v1, v2, v3, the noise power P_{yy}[f,t] will be relatively large. In summary, this results to the fact that Pᵣᵣ[f,t]>P_{zz}[f,t]−CP_{yy}[f,t], giving a scale factor smaller than one. Also for uncorrelated noise, the noise can not be subtracted from the first audio signal z very well, resulting again in Pᵣᵣ[f,t]>P_{zz}[f,t]−CP_{yy}[f,t].

The constant C may be determined in a number of ways. E.g., C may be determined as:

$$C ( f , t ) = \frac{{P}_{zz} [ f , t ]}{{P}_{yy} [ f , t ]} , \qquad \text{[Eq. 8]}$$

in which the Pzz is then determined during non speech time slices (i.e. the noise in z). This may be realized by means of a speech detector, or by looking for low amplitude regions in the temporal z signal, the low amplitude occurring due to the absence of speech. It can be seen then that C*Pyy yields a good estimate of the noise in z. C may also be predetermined by optimization tests depending on the application.

The algorithmic components disclosed may in practice be (entirely or in part) realized as hardware (e.g. parts of an application specific IC) or as software running on a special digital signal processor, a generic processor, etc.

Under computer program product should be understood any physical realization of a collection of commands enabling a processor—generic or special purpose—, after a series of loading steps to get the commands into the processor, to execute any of the characteristic functions of an invention. In particular the computer program product may be realized as data on a carrier such as e.g. a disk or tape, data present in a memory, data traveling over a network connection—wired or wireless—, or program code on paper. Apart from program code, characteristic data required for the program may also be embodied as a computer program product.

It should be noted that the above-mentioned embodiments illustrate rather than limit the invention. Apart from combinations of elements of the invention as combined in the claims, other combinations of the elements are possible. Any combination of elements can be realized in a single dedicated element.

Any reference sign between parentheses in the claim is not intended for limiting the claim. The word “comprising” does not exclude the presence of elements or aspects not listed in a claim. The word “a” or “an” preceding an element does not exclude the presence of a plurality of such elements.

1. An adaptive beamformer, comprising:
a filtered sum beamformer (107) arranged to process input audio signals (u1, u2, u3) from an array of respective microphones (101, 103, 105), and arranged to yield as an output a first audio signal (z) predominantly corresponding to sound from a desired audio source (160), by filtering with a first set of respective adaptable filters (f1(−t), f2(−t), f3(−t)) the input audio signals (u1, u2, u3), the filtered sum beamformer (107) being adaptive in the sense that coefficients of the first set of adaptable filters (f1(−t), f2(−t), f3(−t)) are susceptible to be changed by adding to at least one coefficient a difference value, obtained as a function of an adaptation step size; and
a scaling factor determining unit (170), arranged to provide a scale factor (S) evaluated as a first function (F1), of a ratio (Q) of a first variable (F2) being an estimate of the non-noise corrupted audio signal originating from the desired sound source (160) present in the first audio signal (z), and a second variable (F3) being an estimate of the noise present in the first audio signal (z), the adaptive beamformer being arranged to scale the adaptation step size with the scale factor (S).

2. A sidelobe canceller (100) comprising an adaptive beamformer as claimed in claim 1, further comprising:
an adaptive noise estimator (150), arranged to derive an estimated noise signal (y) by filtering respective noise measurements (x1, x2, x3) derived from the input audio signals (u1, u2, u3) with a second set of adaptable filters (g1, g2); and
a subtracter (142) connected to subtract the estimated noise signal (y) from the first audio signal (z) to obtain a noise cleaned second audio signal (r).

3. An adaptive beamformer as claimed in claim 1, having the coefficients of the first set of filters (f1(−t), f2(−t), f3(−t)) specified in the frequency domain, and being arranged for having the adaptation step size scaled per predetermined frequency range by the ratio (Q) being
(P_{zz}[f,t]−CP_{A(xi)A(xi)}[f,t])/P_{zz}[f,t],
in which P_{zz}[f,t] is a measure of the power of the first audio signal (z) in the predetermined frequency range around frequency f and for a time instant t, P_{A(xi)A(xi)}[f,t] is a measure of the power of a noise signal derived by a noise estimation unit (310) from at least one noise measurement (x1) by a transformation A, and C is a constant.

4. A sidelobe canceller as claimed in claim 2, having the coefficients of the first set of filters (f1(−t), f2(−t), f3(−t)) specified in the frequency domain, and arranged for having the adaptation step size scaled per predetermined frequency range by the ratio (Q) being
(P_{zz}[f,t]−CP_{A(xi)A(xi)}[f,t])/Pᵣᵣ[f,t],
in which P_{zz}[f,t] is a measure of the power of the first audio signal (z) in the predetermined frequency range around frequency f and for a time instant t, P_{A(xi)A(xi)}[f,t] is a measure of the power of a noise signal derived by a noise estimation unit (310) from at least one noise measurement (x1) by a transformation A, Pᵣᵣ[f,t] is a measure of the power of the second audio signal (r), and C is a constant.

5. An adaptive beamformer as claimed in claim 1, comprising a speech detector (165) providing on the basis of the first audio signal (z) a Boolean designation Speech/Noise, and arranged to adapt the first set of filters (f1(−t), f2(−t), f3(−t)) only if the designation is Speech.

6. A sidelobe canceller as claimed in claim 2, comprising a speech detector (165) providing on the basis of the first audio signal (z) or the second audio signal (r) a Boolean designation Speech/Noise, and arranged to adapt the first set of filters (f1(−t), f2(−t), f3(−t)) only if the designation is Speech.

7. An adaptive beamformer as claimed in claim 1, arranged to apply a binary decision function to the ratio (Q), and arranged to adapt the first set of filters (f1(−t), f2(−t), f3(−t)) only if the decision is 1.

8. A handsfree speech communication device comprising an adaptive beamformer as claimed in claim 1.

9. A voice control unit comprising an adaptive beamformer as claimed in claim 1.

10. A consumer apparatus comprising a voice control unit as claimed in claim 9.

11. A tracking device arranged for tracking an audio producing object, comprising an adaptive beamformer as claimed in claim 1.

12. A method of adaptive beamforming, comprising:
beamforming filtering input audio signals (u1, u2, u3) from an array of respective microphones (101, 103, 105) with a first set of respective adaptable beamforming filters (f1(−t), f2(−t), f3(−t)), yielding a first audio signal (z) predominantly corresponding to sound from a desired audio source (160), the beamforming filtering being adaptive in the sense that coefficients of the first set of adaptable filters (f1(−t), f2(−t), f3(−t)) are changeable by adding to at least one coefficient a difference value obtained as a function of an adaptation step size;
determining a scale factor (S) a first function (F1), of a ratio (Q) of a first variable (F2) being an estimate of the non-noise corrupted audio signal originating from the desired sound source (160) present in the first audio signal (z), and a second variable (F3) being an estimate of the noise present in the first audio signal (z); and
scaling the adaptation step size with the scale factor (S).

13. A computer program product comprising respective code for enabling a processor to execute each of the steps of the method of claim 12.
